(19) United States
(12) Patent Application Publication
(10) Pub. No.: US 2008/0047244 A1
(43) Pub. Date: Feb. 28, 2008

(54) Crack Resistant Substrate for an Exhaust Treatment Device

(76) Inventors: Wenzhong Zhang, Savage, MN (US); Zhixin (Jason) Hou, Maplewood, MN (US)

Correspondence Address: MERCHANT & GOULD PC, P.O. BOX 2903, MINNEAPOLIS, MN, 55402-0903, US

(21) Appl. No.: 11/835,141

(22) Filed: Aug. 7, 2007

Related U.S. Application Data
(60) Provisional application No. 60/835,953, filed on Aug. 7, 2006.

(51) Int. Cl. B05D 5/00; B01D 46/24

(52) U.S. Cl. 55/524; 427/256

(57) ABSTRACT

The present disclosure relates to an exhaust treatment article including a substrate having a length that extends along a central longitudinal axis from a first end to second end. The substrate has walls defining a honeycomb arrangement of longitudinal passages that extend along the central longitudinal axis between the first and second ends. The substrate also has first, second and third zones that each extend along a portion of the length of the substrate with the second zone being positioned axially between the first and third zones. The exhaust treatment article also includes a washcoat layer coated on the first and third zones but not coated on the second zone.

### CROSS-REFERENCE TO RELATED APPLICATION

This application claims the benefit of U.S. Provisional Patent Application Ser. No. 60/835,953, filed on Aug. 7, 2006, which application is hereby incorporated by reference in its entirety.

### TECHNICAL FIELD

The present invention relates generally to exhaust treatment devices having cores such as catalytic converters or diesel particulate filters.

### BACKGROUND

To reduce air pollution, vehicle emissions standards have become increasingly more stringent. With respect to both internal combustion and diesel engines, catalytic converters have been used to reduce the concentration of pollutant gases (e.g., hydrocarbons, carbon monoxide, NO, NO₂, etc.) in the exhaust stream. Also, with respect to diesel engines, diesel particulate filters have been used to reduce the concentration of particulate matter (e.g., soot) in the exhaust stream.

A typical catalytic converter (i.e., a diesel oxidation catalyst or DOC) includes a substrate mounted in an outer casing or “can.” The substrate defines a plurality of longitudinal channels that extend through the catalytic converter. Substrates are often formed as extruded ceramic monoliths. Specific materials of which catalytic converter substrates are commonly made include cordierite, mullite, alumina, SiC, refractory metal oxides, or other materials. Catalytic converter substrates typically include a catalyst. For example, the substrate monolith is often impregnated with a catalyst or coated with a catalyst. Example catalysts include precious metals such as platinum, palladium and rhodium. The catalysts can also include other types of materials such as alumina, cerium oxide, base metal oxides (e.g., lanthanum, vanadium, etc.) or zeolites. Rare earth metal oxides can also be used as catalysts. Example catalytic converter configurations having porous ceramic substrates/cores are described in U.S. Pat. No. 5,355,973, that is hereby incorporated by reference in its entirety.

A typical diesel particulate filter includes a ceramic substrate mounted in an outer casing. The ceramic substrate is porous and defines a plurality of longitudinal channels. Adjacent longitudinal channels are plugged at opposite ends of the core as described in U.S. Pat. No. 4,851,015 that is hereby incorporated by reference in its entirety. The plugged ends forces exhaust gases to flow through the walls of the substrate so that soot is collected on the walls as the gases pass therethrough. For some applications, a catalyst can be provided on the substrate such that the filter functions like a catalytic converter to reduce the concentration of pollutant gases. Catalysts also facilitate regenerating diesel particulate filters at lower temperatures. Specific materials of which diesel particulate filter substrates are commonly made include cordierite, mullite, alumina, SiC, refractory metal oxides, or other materials.

Substrates for exhaust treatment devices (e.g., diesel particulate filters, catalytic converters, and other exhaust treatment devices) are prone to cracking. It is believed that cracking is often caused by thermal stresses within the substrate that occur when the substrate rapidly heats up or cools down. There is a need to provide exhaust treatment device substrates that resist cracking.

### SUMMARY

The various aspects of the present disclosure relate to exhaust treatment device substrate configurations that are designed to resist cracking. In certain embodiments, the substrates are zone coated with wash coat to resist cracking. In one embodiment, a substrate is coated at the ends with a wash coat including a catalyst, and is not coated with wash coat at the middle of the substrate.

A variety of other aspects of the invention are set forth in part in the description that follows, and in part will be apparent from the description, or may be learned by practicing the invention. The aspects of the invention relate to individual features as well as combinations of features. It is to be understood that both the foregoing general description and the following detailed description are exemplary and explanatory only and are not restrictive of the broad aspects of the invention.

### BRIEF DESCRIPTION OF THE DRAWINGS

FIG. 1 shows one half of a prior art diesel particulate filter, the depicted top surface defines a jagged crack line that mates with the other half of the cracked diesel particulate filter;

FIG. 2 is a stress diagram showing stress loading in a prior art diesel particulate filter during use; and

FIG. 3 is a sectional view of a diesel particulate filter having features that are examples of inventive aspects in accordance with the principles of the present disclosure.

### DETAILED DESCRIPTION

In the following detailed description, references are made to the accompanying drawings that depict various embodiments in which the invention may be practiced. It is to be understood that other embodiments may be utilized and structural and functional changes may be made without departing from the scope of the present invention.

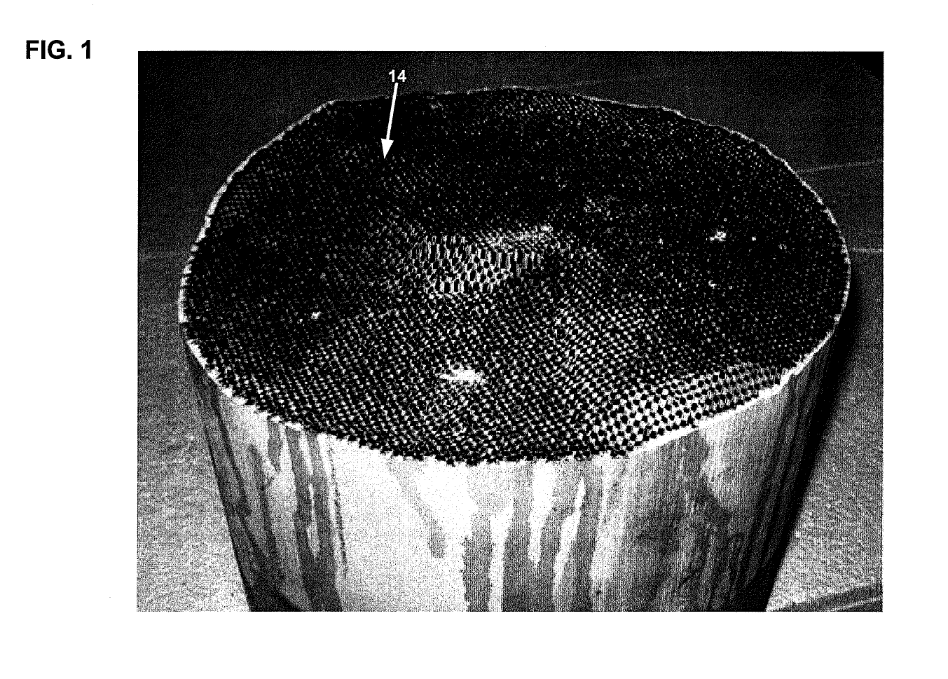

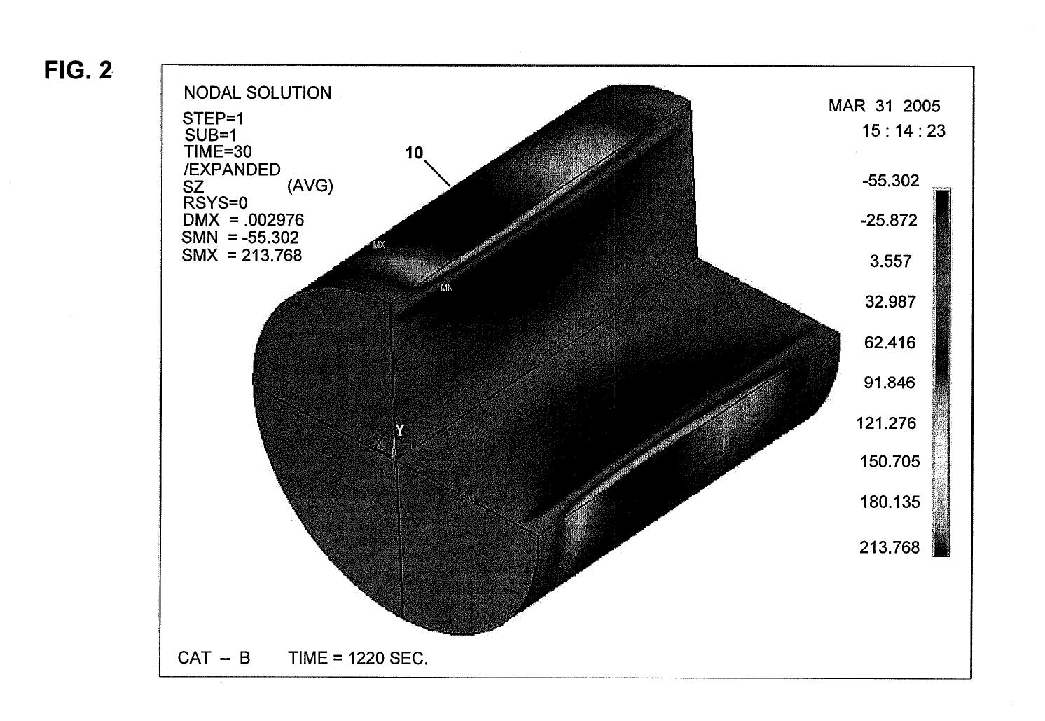

Ceramic honeycomb filters have been widely used for cleaning of diesel engine exhaust by removing soot particles. Since the diesel engines are the major labor force for transportation in the world and they typically out-live gasoline engines by 3 to 10 times in term of mileage, this requires ceramic exhaust filters to be long-lived to match with what a diesel engine can do. This made the ceramic filter robustness very important in medium and heavy duty diesel engine applications. Since most of the filtrated soot on these filters needs to be burn-off on board, it makes the filter robustness even more important for developing ceramic filter into an after treatment device. To make ceramic filter more robust, filter materials design is crucial, but takes long time to come up with a new suitable material. New materials such as SiC, SiN, mullite, aluminum titanate have been widely studied. Among all the materials mentioned above, cordierite has been the one most widely researched and the cheapest so far to make. However, cordierite filters can have ring-off cracks from fatigues generated by long time heat-up cycles (see FIG. 1 where half 12 of a cracked filter is shown with the jagged top surface 14 being formed by the crack line between the two filter halves). Unlike SiC, cordierite filters also have relative lower soot capacity that would not cause thermal shock cracking upon regeneration. With above mentioned two unfavorable characteristics, they are worthy to be well-engineered for medium and heavy duty applications because of relatively low cost for making cordierite filters. For the soot capacity, filter soot loading can be well controlled to prevent the filter being overloaded and thus prevent the thermal shock cracking. For ring-off cracks, there are many factors can be affecting the filter behavior upon the heat-up cycles. Physical properties such as thermal expansion coefficient, Young's modules, radial temperature gradients in side the filter etc are key parameters related to stress on the filter body which cause the filter eventually to ring-off crack. As shown in FIG. 2, the highest stress on the filter is located at middle section of the filter (high stress is illustrated by the dark band that surrounds the circumference of the filter body at the middle section) where the ring-off cracks happened most of the time as shown in FIG. 1.

Catalyst wash coating on the filter can alter the physical properties easily since wash coating materials and cordierite materials have different coefficients of thermal expansion (CTE), may increase CTE significantly. To minimize the stress at selected locations of the substrate, wash coat can be selectively applied at different thicknesses/concentrations at different zones of the substrate. For example, in one embodiment, wash coat can be applied to the ends of the substrate, and not applied to a middle region of the substrate. In an example embodiment, a middle zone of at least 3 inches in length is not coated with wash coat, while the ends are coated with wash coat. The wash coat at the ends can have the same or different catalyst loadings. In still other embodiments, different types of wash coats can be applied to different zones of the substrate.

In certain embodiments, the uncoated zone at the middle of the substrate has an axial length that extends for at least ¼ the entire length of the substrate. In other embodiments, the uncoated zone at the middle of the substrate has an axial length that extends for at least ⅓ the entire length of the substrate. In still other embodiments, the uncoated zone at the middle of the substrate has an axial length that extends for at least ½ the entire length of the substrate.

Example wash coat materials for coating the ends of the substrate include CeO2, ZrO2, Al2O3, perovskite, manganese oxide, and vanadium oxide. Examples of catalysts present in wash coat layers include precious metals such as platinum, palladium and rhodium. Wash coat materials such as alumina, cerium oxide, base metal oxides (e.g., lanthanum, vanadium, etc.) or zeolites can also provide some catalytic action. A typical wash coat loading on the substrate can be 0.01 g/cubic inch to 0.3 g/cubic inch at the coated zone. A preferred wash coat loading is 0.1 to 0.25 g/cubic inch at the coated zone. A typical precious metal loading at the coated zones can be 5 g/cubic foot to 50 g/cubic foot. A preferred precious metal loading is 5 g/cubic foot to 25 g/cubic foot.

One example substrate in accordance with the principles of the present disclosure is a cordierite wall-flow diesel particulate filter substrate with a 12″ axial length. Both ends of the substrate are coated with wash coat zones of 3 inches in length. A middle region of 6 inches in length is not coated with wash coat. The wash coat loading of the end zones is 0.1 g/cubic inches and the precious metal loading at the end zones is 7.5 g/cubic feet.

Another example substrate in accordance with the principles of the present disclosure is a cordierite wall-flow diesel particulate filter substrate with a 12″ axial length. Both ends of the substrate are coated with wash coat zones of 4 inches in length. A middle region of 6 inches in length is not coated with wash coat. The wash coat loading of the end zones is 0.13 g/cubic inches and the precious metal loading at the end zones is 10 g/cubic feet.

Substrates in accordance with the principles of the present disclosure typically have an extruded ceramic construction with a pattern of a side-by-side, generally parallel passages extending axially through the substrates. The passages are defined by porous cell walls that separate adjacent passages from one another. Example materials for constructing the substrates include cordierite, mullite, alumina, SiC, refractory metal oxides, or other materials.

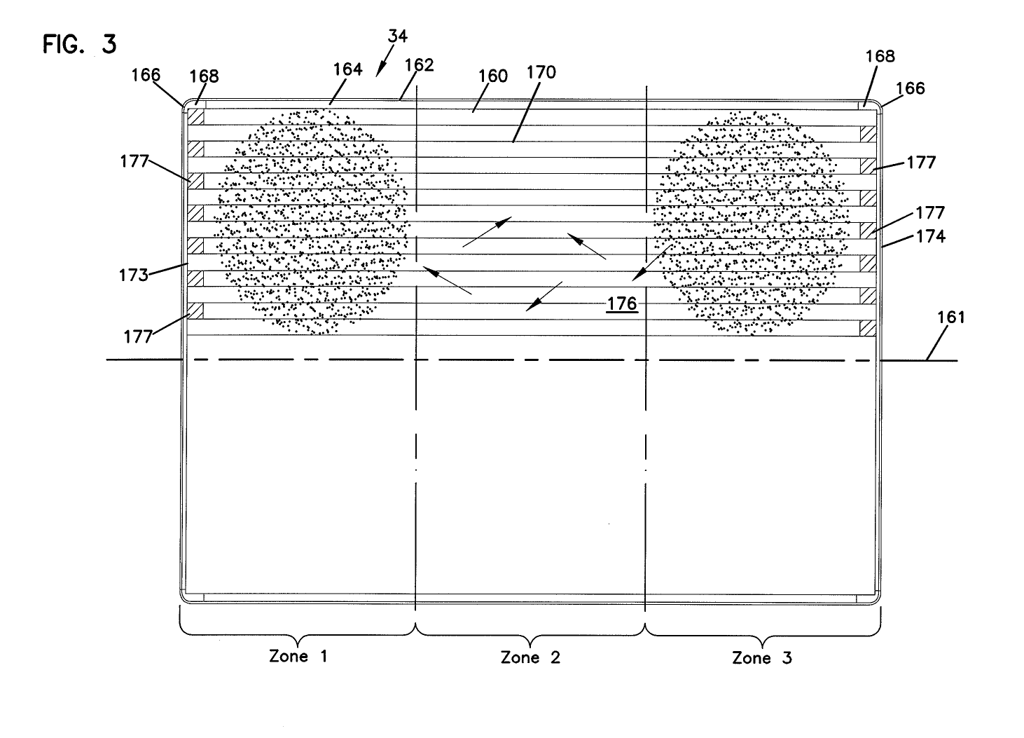

FIG. 3 shows a diesel particulate filter (DPF) 34 in accordance with the principles of the present disclosure. The DPF 34 is depicted as wall-flow filter having a substrate 160 housed within an outer casing 162. A mat layer 164 can be mounted between the substrate 160 and the casing 162. Ends 166 of the casing can be bent radially inwardly to assist in retaining the substrate 160 within the casing 162. End gaskets 168 can be used to seal the ends of the DPF 34 to prevent flow from passing through the mat layer 164 to bypass the substrate 160.

Still referring to FIG. 3, the substrate 160 includes walls 170 defining a honeycomb arrangement of longitudinal passages 172 (i.e., channels) that extend from a downstream end 173 to an upstream end 174 of the substrate 160. The substrate 160 has a central longitudinal axis 161. The passages 172 are selectively plugged by plugs 177 adjacent the upstream and downstream ends 173, 174 such that exhaust flow is forced to flow radially through the walls 170 between the passages 172 in order to pass through the DPF 34. As shown at FIG. 3, this radial wall flow is represented by arrows 176.

In alternative embodiments, the diesel particulate filter can have a configuration similar to the diesel particulate filter disclosed in U.S. Pat. No. 4,851,015 that is hereby incorporated by reference in its entirety. Example materials for manufacturing the DPF substrate include cordierite, mullite, alumina, SiC, refractory metal oxides or other materials conventionally used at DPF substrates.

The DPF 34 preferably has a particulate mass reduction efficiency greater than 75%. More preferably, the DPF 30 has a particulate mass reduction efficiency greater than 85%. Most preferably, the DPF 30 has a particulate mass reduction efficiency equal to or greater than 90%. For the purposes of this specification, particulate mass reduction efficiency is determined by subtracting the particulate mass that enters the DPF from the particulate mass that exits the DPF, and by dividing the difference by the particulate mass that enters the DPF. The test duration and engine cycling during testing are preferably determined by the federal test procedure (FTP) heavy-duty transient cycle that is currently used for emission testing of heavy-duty on-road engines in the United States (see C.F.R. Tile 40, Part 86.1333).

The substrate 160 has first and third zones that are coated with a wash coat. The first and third zones are located at the ends of the substrate 160. The substrate 160 also includes a second, middle zone positioned between the first and third zones. The second zone is not coated with wash coat. In the depicted embodiment, the second zone extends at least ⅓ the total axial length of the substrate 160.

The above specification provides examples of how certain inventive aspects may be put into practice. It will be appreciated that the inventive aspects can be practiced in other ways than those specifically shown and described herein without departing from the spirit and scope of the inventive aspects.

What is claimed is:

1. An exhaust treatment article comprising:
a substrate having a length that that extends along a central longitudinal axis from a first end to second end, the substrate having walls defining a honeycomb arrangement of longitudinal passages that extend along the central longitudinal axis between the first and second ends, the substrate having first, second and third zones that each extend along a portion of the length of the substrate, the second zone being positioned axially between the first and third zones; and
a washcoat layer coated on the first and third zones but not coated on the second zone.

2. The exhaust treatment article of claim 1, wherein the substrate is a wall-flow diesel particulate filter substrate.

3. The exhaust treatment article of claim 1, wherein longitudinal passages are selectively plugged at the first and second ends of the substrate to cause exhaust to flow through the walls of the substrate when the substrate is used to treat exhaust.

4. The exhaust treatment article of claim 1, wherein the second zone extends for at least one quarter of the length of the substrate.

5. The exhaust treatment article of claim 1, wherein the second zone extends for at least one third of the length of the substrate.

6. The exhaust treatment article of claim 1, wherein the second zone extends for at least one half of the length of the substrate.

7. The exhaust treatment article of claim 1, wherein the second zone includes a middle region of the substrate, and the first and third zones include end regions of the substrate.

8. The exhaust treatment article of claim 1, wherein the first and zones have washcoat loadings in the range of 0.01 gram per cubic inch to 0.3 gram per cubic inch.

9. The exhaust treatment article of claim 1, wherein the first and zones have washcoat loadings in the range of 0.1 gram per cubic inch to 0.25 gram per cubic inch.

10. The exhaust treatment article of claim 1, wherein the washcoat layer has a precious metal loading in the range of 5 grams per cubic foot to 50 grams per cubic foot.

11. The exhaust treatment article of claim 1, wherein the washcoat layer includes a material selected from the following materials: CeO2, ZrO2, Al2O3, perovskite, manganese oxide, or vanadium oxide.

12. The exhaust treatment article of claim 1, wherein the washcoat layer includes a precious metal catalyst.

13. The exhaust treatment article of claim 1, wherein the washcoat layer includes a material selected from the following materials: alumina, cerium oxide, a base metal oxide or a zeolite.

14. The exhaust treatment article of claim 1, wherein the substrate is mounted in an outer casing, and wherein a mat layer is positioned between the outer casing and the substrate.

15. The exhaust treatment article of claim 1, wherein the substrate includes cordierite.

16. A method for reducing the likelihood of core cracking in an exhaust treatment substrate, the substrate along a central longitudinal axis from a first end to second end, the substrate having walls defining a honeycomb arrangement of longitudinal passages that extend along the central longitudinal axis between the first and second ends, the method comprising:
coating end portions of the substrate with a washcoat while leaving a middle region of the substrate uncoated with the washcoat.
